(19) United States
(12) Patent Application Publication
(10) Pub. No.: US 2025/0199242 A1
(43) Pub. Date: Jun. 19, 2025

(54) OPTICAL COMPONENT AND OPTICAL MODULE

(71) Applicant: SUMITOMO ELECTRIC INDUSTRIES, LTD., Osaka (JP)

(72) Inventor: Yasutaka MIZUNO, Osaka (JP)

(21) Appl. No.: 18/978,044

(22) Filed: Dec. 12, 2024

(30) Foreign Application Priority Data
Dec. 15, 2023 (JP) 2023-212251

(51) Int. Cl. G02B 6/26; G02B 6/32

(52) U.S. Cl. CPC G02B 6/262; G02B 6/32

(57) ABSTRACT

An optical component according to one embodiment includes a first surface; a second surface intersecting the first surface; and a third surface intersecting the first surface and the second surface in a cross section orthogonal to both the first surface and the second surface. The third surface includes the convex mirror that reflects light incident on the first surface toward the second surface. The second surface includes a lens that emits the light, which is reflected from the convex mirror, as collimated light.

### CROSS-REFERENCE TO RELATED APPLICATION

This application claims priority from Japanese Patent Application No. 2023-212251, filed on Dec. 15, 2023, the entire subject matter of which is incorporated herein by reference.

### TECHNICAL FIELD

The present disclosure relates to an optical component and an optical module.

### BACKGROUND

U.S. Unexamined Patent Publication No. 2019/0324211 describes a wideband photonic bump (WBB) disposed on an optical waveguide. The WBB is mounted on a photonic integrated circuit (PIC). The PIC includes an inverse taper, a positive taper, a curved mirror, and an inclined plane mirror. A light beam propagates through the inverse taper, and the positive taper expands the light beam of the inverse taper. The light beam expanded by the positive taper is reflected by the inclined plane mirror.

U.S. Unexamined Patent Publication No. 2023/0194806 describes a substrate, a silicon photonics chip (SiPh chip), and a photonic plug. The SiPh chip includes a curved mirror and an inclined plane mirror. The photonic plug includes a second inclined plane mirror and a second curved mirror. Light from an optical fiber is incident on the second inclined plane mirror, and the second inclined plane mirror reflects the light toward the curved mirror. The curved mirror reflects the light from the second inclined plane mirror toward the inclined plane mirror, and the light reflected by the inclined plane mirror is incident on a waveguide of the SiPh chip.

Japanese Unexamined Patent Publication No. H7-92310 describes a beam expansion reflecting prism having an incident surface, a reflecting surface, and an emitting surface. The reflecting surface is at an angle of 45° with respect to the incident surface. The emitting surface is at an angle of 45° with respect to the reflecting surface. The reflecting surface includes a convex spherical mirror portion of which a central portion is inserted into a prism body. A portion of an optical path from a reflecting portion of the convex spherical mirror portion to the emitting surface in the prism body functions as a concave lens. Therefore, the beam diameter of light emitted from the emitting surface becomes larger than that of incident light.

Japanese Unexamined Patent Publication No. H8-36776 describes an optical pickup device. The optical pickup device includes a laser diode that emits light; a mirror that reflects the light from the laser diode; an objective lens that focuses the light reflected by the mirror, and an optical disk that receives the light focused by the objective lens. The mirror includes a convex mirror. This mirror functions as light diverging means for increasing the beam diameter at the objective lens.

### SUMMARY

An optical component according to the present disclosure includes a first surface; a second surface intersecting the first surface; and a third surface intersecting the first surface and the second surface in a cross section orthogonal to both the first surface and the second surface. The third surface includes a convex mirror that reflects light incident on the first surface toward the second surface. The second surface includes a lens that emits the light, which is reflected from the convex mirror, as collimated light.

### BRIEF DESCRIPTION OF THE DRAWINGS

FIG. 1 is a perspective view showing an optical module including an optical component according to an embodiment.

FIG. 2 is a view schematically showing a cross section of the optical module of FIG. 1.

FIG. 3 is a perspective view showing the optical component according to the embodiment.

FIG. 4 is a side view, a front view, and a plan view showing the optical component according to the embodiment.

FIG. 5 is a cross-sectional view showing the optical component according to the embodiment.

FIG. 6 is a view schematically showing a cross section of an optical module according to a first modification example.

FIG. 7 is a view schematically showing a cross section of an optical module according to a second modification example.

FIG. 8 is a view schematically showing a cross section of an optical module according to a third modification example.

FIG. 9 is a view schematically showing a cross section of an optical module according to a fourth modification example.

FIG. 10 is a view schematically showing a cross section of an optical module according to a fifth modification example.

### DETAILED DESCRIPTION

In an optical module including optical components such as a lens and a mirror, a long optical path length may be required to emit light with an expanded beam diameter. In this case, there is a concern that the size of the optical components and the optical module is increased. Therefore, there is a demand to be able to shorten the optical path length of the optical components to mount the optical components at high density and realize downsizing of the optical components and the optical module.

An object of the present disclosure is to provide an optical component and an optical module that enable high-density mounting.

According to the present disclosure, it is possible to provide the optical component and an optical module that enables high-density mounting.

### Description of Embodiment of Present Disclosure

First, embodiments of an optical component and an optical module according to the present disclosure will be listed and described below.
(1) An optical component according to one embodiment includes a first surface; a second surface intersecting the first surface; and a third surface intersecting the first surface and the second surface in a cross section orthogonal to both the first surface and the second surface. The third surface includes a convex mirror that reflects light incident on the first surface toward the second surface. The second surface includes a lens that emits the light, which is reflected from the convex mirror, as collimated light.

The optical component has the first surface, the second surface, and the third surface, and the light is incident on the first surface. The third surface includes the convex mirror that reflects the light incident on the first surface toward the second surface. Since the third surface includes the convex mirror, the beam diameter of the light traveling from the convex mirror toward the second surface can be expanded. The second surface includes the lens, and the lens emits the light, which is reflected from the convex mirror, as collimated light. Therefore, the light of which the beam diameter is expanded by the convex mirror can be emitted to the outside of the optical component as collimated light. In the optical component, since the convex mirror that expands the beam diameter of the light is formed on the third surface, and the lens that converts the light into collimated light is formed on the second surface intersecting the third surface, the need for a long optical path length can be eliminated. Therefore, the optical path length of the optical components can be shortened, and the optical components can be mounted at high density.
(2) in the above (1), when a direction in which the third surface

extends in the cross section is defined as an X direction, a direction in which the third surface extends and which is orthogonal to the X direction is defined as a Y direction, and a direction orthogonal to the third surface is defined as a Z direction, a length of the optical component in the X direction, a length of the optical component in the Y direction, and a length of the optical component in the Z direction may be 300 μm or less. In this case, since the optical components can be downsized, the optical components can be mounted at higher density.
(3) In the above (1) or (2), when a direction in which the third surface extends in the cross section is defined as an X direction, a direction in which the third surface extends and which is orthogonal to the X direction is defined as a Y direction, and a direction orthogonal to the third surface is defined as a Z direction, a curvature of the convex mirror when cut by a plane extending in both the Z direction and the X direction may be different from a curvature of the convex mirror when cut by a plane extending in both the Y direction and the Z direction. In this case, the light emitted from the lens can be made nearly symmetrical.
(4) In any one of the above (1) to (3), an angle of the third surface with respect to an optical axis of the light incident on the first surface may be 35° or more and 42° or less. In this case, the non-reflected component of the light at the convex mirror can be reduced.
(5) An optical module according to one aspect of the present disclosure includes a first optical component including the optical component described above, and an optical fiber fixed to the first surface of the optical component; and a second optical component including the optical component described above, and a silicon photonics element fixed to the first surface of the optical component. The lens of the optical component of the first optical component and the lens of the optical component of the second optical component are optically coupled to each other.
(6) An optical module according to another aspect of the present disclosure includes a first optical component including the optical component described above, and an optical fiber fixed to the first surface of the optical component; and a second optical component including the optical component described above, and a silicon photonics element fixed to the optical component. The silicon photonics element includes an end face facing the first surface of the optical component, and a protruding portion protruding from the end face. The optical component of the second optical component includes a fixing portion fixed to the protruding portion, and a convex lens optically coupled to the silicon photonics element in a state where the fixing portion is fixed to the protruding portion.
(7) An optical module according to still another aspect of the present disclosure includes a first optical component including the optical component described above, and a glass substrate in which a first recess in which the first surface of the optical component is fixed and into which the optical component is inserted is formed; and a second optical component including the optical component described above, and a silicon photonics element in which a second recess in which the first surface of the optical component is fixed and into which the optical component is inserted is formed. The lens of the optical component of the first optical component and the lens of the optical component of the second optical component are optically coupled to each other.

In each of the optical modules described above, since each of the first optical component including the optical fiber or the glass substrate and the second optical component including the silicon photonics element includes the optical component described above, the optical path length can be shortened, and the optical components and the optical modules can be mounted at high density.

### Details of Embodiment of Present Disclosure

Specific examples of an optical component and an optical module according to an embodiment will be described below with reference to the drawings. It is intended that the present invention is not limited to the following examples and includes all modifications within the scope of the claims and equivalents to the claims. In the description of the drawings, the same or corresponding elements are denoted by the same reference signs, and duplicate descriptions will be omitted as appropriate. The drawings may be depicted partially in a simplified or exaggerated manner for ease of understanding, and dimensional ratios and the like are not limited to those shown in the drawings.

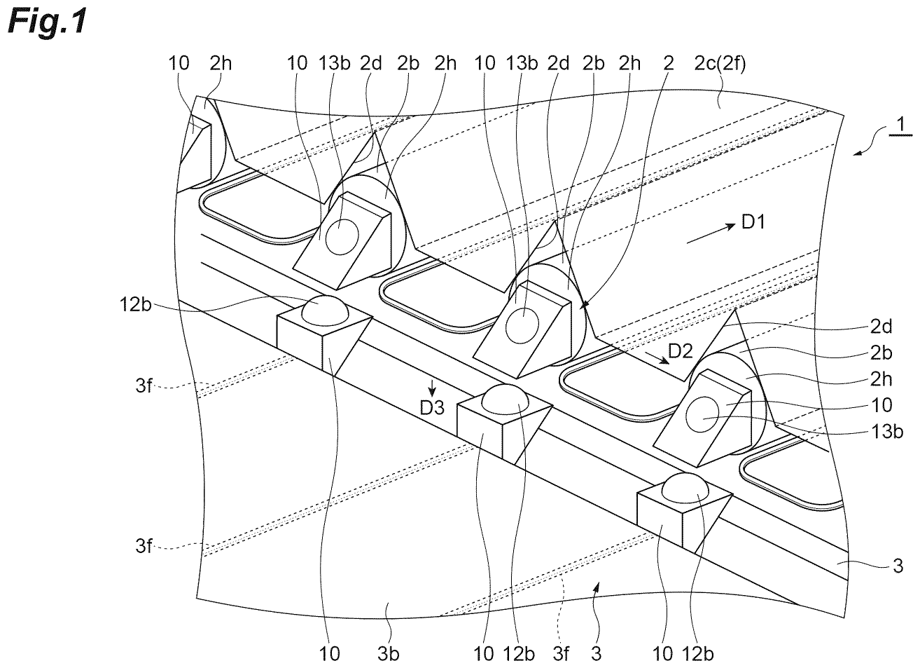

FIG. 1 is a perspective view showing an optical module 1 and an optical component 10 according to an embodiment. As shown in FIG. 1, the optical module 1 includes a first optical component 2 and a second optical component 3. The first optical component 2 includes an optical fiber 2b and the optical component 10 fixed to an end face 2h of the optical fiber 2b. The second optical component 3 includes a silicon photonics element 3b and the optical component 10 fixed to the silicon photonics element 3b. For example, the optical component 10 is produced by a 3D printer. However, a method for producing the optical component 10 is not particularly limited. The material of the optical component 10 may be resin or glass.

The first optical component 2 includes, for example, a fiber array 2c that holds the optical fiber 2b. The fiber array 2c includes the optical fiber 2b and a V-groove substrate 2f in which a V-groove 2d into which the optical fiber 2b is inserted is formed. For example, the optical fiber 2b is fixed in the V-groove 2d. For example, the fiber array 2c may further include a pressing substrate (not shown), and the optical fiber 2b is pressed into the V-groove 2d by the pressing substrate. In the first optical component 2, the optical fiber 2b and the V-groove 2d extend along a first direction D1. The first optical component 2 includes a plurality of the optical fibers 2b, and the V-groove substrate 2f includes a plurality of the V-grooves 2d. The plurality of optical fibers 2b and the plurality of V-grooves 2d are arranged along a second direction D2 intersecting the first direction D1. A plurality of the individual silicon photonics elements 3b are formed on one wafer. When the plurality of individual silicon photonics elements 3b are formed on the wafer, as shown in FIG. 1, another second optical component 3 is disposed adjacent to one second optical component 3 along the second direction D2.

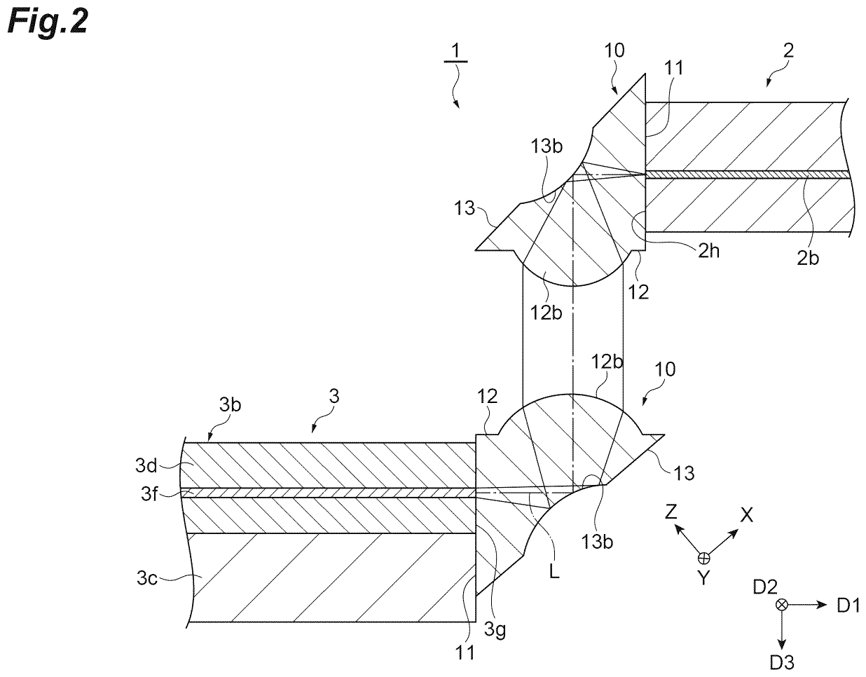

FIG. 2 is a view schematically showing a cross section of the first

optical component 2 and the second optical component 3. As shown in FIGS. 1 and 2, the silicon photonics element 3b includes, for example, a Si layer 3c and a SiN layer 3d laminated on the Si layer 3c. The silicon photonics element 3b includes an optical waveguide 3f, and for example, the optical waveguide 3f is formed in the SiN layer 3d. The silicon photonics element 3b includes a plurality of the optical waveguides 3f, and the plurality of optical waveguides 3f are arranged along the second direction D2.

For example, the optical module 1 includes a plurality of the optical components 10, and the plurality of optical components 10 are arranged along the second direction D2. The plurality of optical components 10 may be arranged in an array. The silicon photonics element 3b has an end face 3g to which the optical components 10 are fixed. The end face 3g extends along the second direction D2 and the third direction D3 at an end portion of the silicon photonics element 3b in the first direction D1. The third direction D3 is a direction intersecting (as one example, orthogonal to) both the first direction D1 and the second direction D2.

The optical component 10 fixed to the end face 2h of the optical fiber 2b and the optical component 10 fixed to the end face 3g of the silicon photonics element 3b are arranged along the third direction D3. For example, the optical component 10 fixed to the end face 2h is optically coupled to the optical component 10 fixed to the end face 3g. Accordingly, the optical fiber 2b and the silicon photonics element 3b are optically coupled to each other through two optical components 10.

Hereinafter, a direction in which the optical component 10 fixed to the optical fiber 2b is provided when viewed from the optical component 10 fixed to the silicon photonics element 3b may be referred to as the top, upper side, or upward, and a direction in which the optical component 10 fixed to the silicon photonics element 3b is provided when viewed from the optical component 10 fixed to the optical fiber 2b may be referred to as the bottom, lower side, or downward. In the present embodiment, the third direction D3 coincides with a downward direction. However, these directions are for convenience of description, and do not limit the disposition positions, directions, or the like of objects.

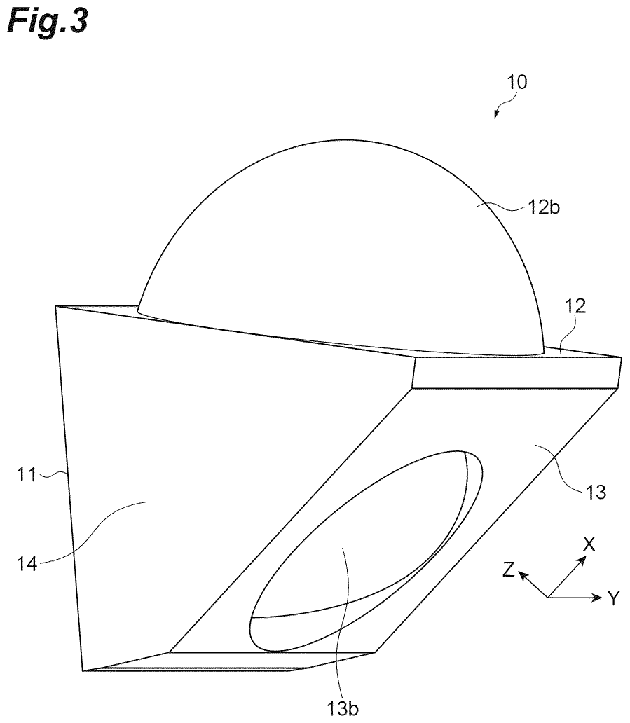

Next, the optical component 10 will be described in detail. FIG. 3 is a perspective view showing the optical component 10. As shown in FIGS. 2 and 3, the optical component 10 has a first surface 11; a second surface 12 intersecting the first surface 11; and a third surface 13 intersecting the first surface 11 and the second surface 12 in a cross section orthogonal to both the first surface 11 and the second surface 12. In the cross section, a direction in which the third surface 13 extends, a direction in which the third surface 13 extends and which is orthogonal to the X direction, and a direction orthogonal to the third surface 13 will be described as an X direction, a Y direction, and a Z direction, respectively.

The first surface 11 is a surface on which light L is incident from the outside of the optical component 10. For example, the light L propagating through the optical waveguide 3f or the light L propagating through the optical fiber 2b is incident on the first surface 11. The first surface 11 extends along the second direction D2 and the third direction D3. The third surface 13 includes a convex mirror 13b that reflects the light L incident on the first surface 11 toward the second surface 12. The convex mirror 13b protrudes from the third surface 13 when viewed from the light L incident on the first surface 11. The second surface 12 includes a lens 12b that emits the light L, which is reflected by the convex mirror 13b, as collimated light. The shape of the lens 12b when viewed from above (in a plan view) is, for example, a circular shape. For example, the lens 12b is an aspherical lens. When the lens 12b is an aspherical lens, optical coupling efficiency when two optical components 10 face each other and are optically coupled to each other can be improved compared to when the lens 12b is a spherical lens. However, for example, when high efficiency is not required for optical coupling, the lens 12b may be a spherical lens. The shape of the lens 12b can be changed as appropriate.

For example, the lens 12b of the optical component 10 of the first optical component 2 and the lens 12b of the optical component 10 of the second optical component 3 are optically coupled to each other. For example, the light L incident on the first surface 11 is reflected toward the lens 12b by the convex mirror 13b, and the divergence angle of the light L is increased. When the light L of which the divergence angle is increased is incident on the lens 12b, the light L is converted into collimated light by the lens 12b, and is emitted from the lens 12b to the outside of the optical component 10. In the present disclosure, “collimated light” includes not only strictly parallel light, but also light as long as the light is more convergent after transmitting through the lens 12b than before transmitting therethrough.

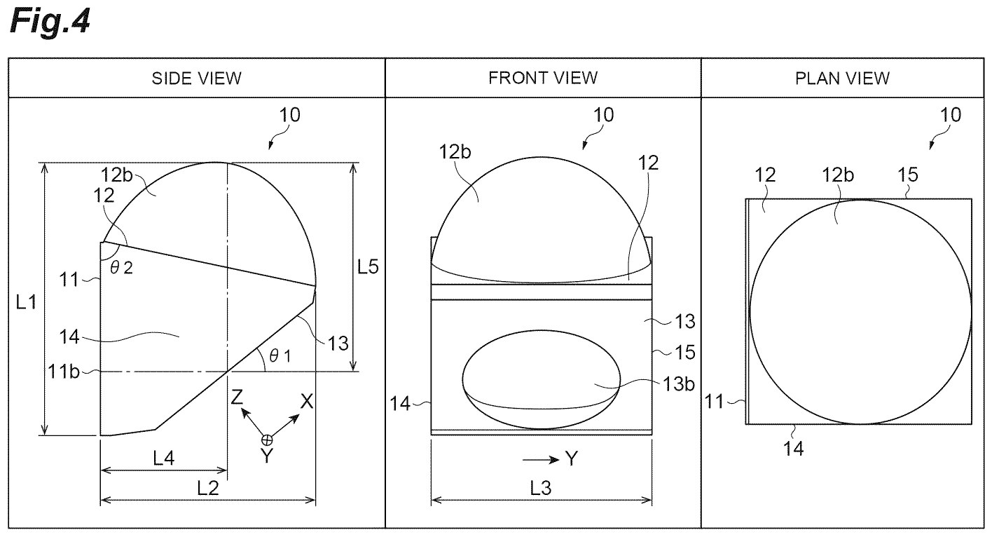

FIG. 4 shows a side view of the optical component 10 when the optical component 10 is viewed along the Y direction, a front view of the optical component 10 when the third surface 13 is viewed along a direction orthogonal to the first surface 11, and a plan view of the optical component 10 when the second surface 12 is viewed along the first surface 11. As shown in FIGS. 3 and 4, the optical component 10 has a fourth surface 14 extending in both the Z direction and the X direction at an end portion of the optical component 10 in the Y direction, and a fifth surface 15 extending in both the Z direction and the X direction at an end portion of optical component 10 opposite to the fourth surface 14.

For example, a length of the optical component 10 in the X direction, a length of the optical component 10 in the Y direction, and a length of the optical component 10 in the Z direction are 300 μm or less. For example, a length L1 of the optical component 10 in the third direction D3 is 50 μm or more and 100 μm or less (as one example, 85 μm). A length L2 of the optical component 10 in the direction orthogonal to the first surface 11 is, for example, 50 μm or more and 80 μm or less (as one example, 66 μm). A length L3 of the optical component 10 in the Y direction is, for example, 50 μm or more and 80 μm or less (as one example, 67 μm). A length of the lens 12b in the Y direction may be approximately the same as the length L3 of the optical component 10 in the Y direction.

The first surface 11 includes a connecting portion 11b connected to the optical waveguide 3f (or the optical fiber 2b). For example, a length L4 of an optical axis of the light L extending from the connecting portion 11b to the third surface 13 is 20 μm or more and 30 μm or less (as one example, 25 μm). For example, a length L5 of the optical axis of the light L extending from the third surface 13 to the lens 12b is 50 μm or more and 70 μm or less (as one example, 60 μm). For example, an angle θ1 of the third surface 13 with respect to the optical axis of the light L incident on the first surface 11 is 35° or more and 42° or less (as one example, 39°). An angle θ2 of the second surface 12 with respect to the first surface 11 is, for example, 80° or more and 90° or less (as one example, 84°).

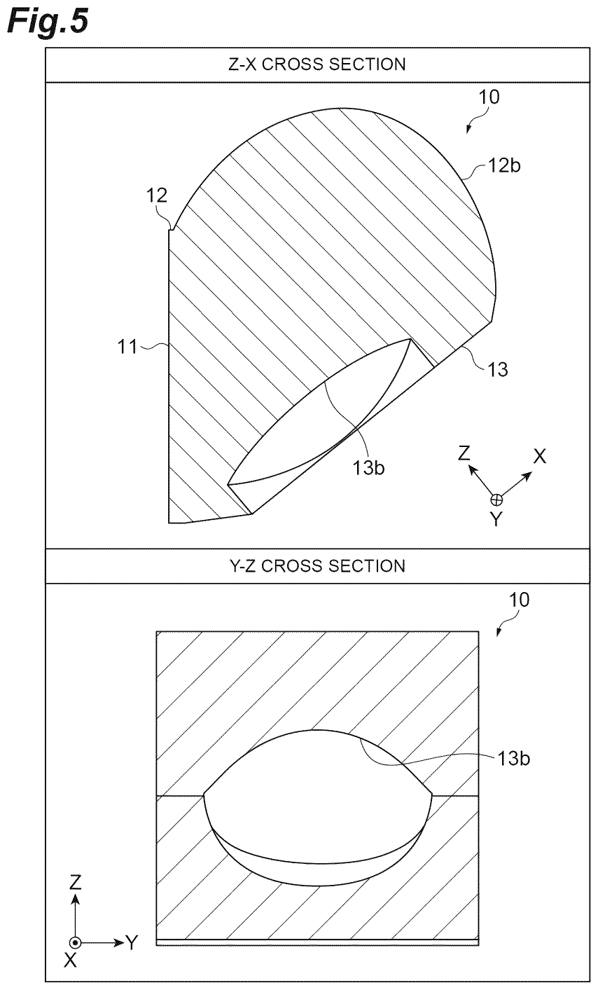

For example, when viewed in the direction orthogonal to the first surface 11, the convex mirror 13b has an elliptical shape having a major axis extending along the Y direction. In addition, the convex mirror 13b has a circular shape when viewed along the Z direction. FIG. 5 shows a cross section of the convex mirror 13b when cut by a plane extending in both the Z direction and the X direction (Z-X cross section), and a cross section of the convex mirror 13b when cut by a plane extending in both the Y direction and the Z direction (Y-Z cross section). Each cross section in FIG. 5 is a cross section passing through the center of the convex mirror 13b. As shown in FIG. 5, a curvature of the convex mirror 13b when cut by a plane extending in both the Z direction and the X direction is different from a curvature of the convex mirror 13b when cut by a plane extending in both the Y direction and the Z direction.

In the present embodiment, the curvature of the convex mirror 13b in the Z-X cross section is smaller than the curvature of the convex mirror 13b in the Y-Z cross section. Namely, a radius of curvature of the convex mirror 13b in the Z-X cross section is larger than a radius of curvature of the convex mirror 13b in the Y-Z cross section. For example, the radius of curvature of the convex mirror 13b in the Z-X cross section is 50 μm or more and 100 μm or less (as one example, 70 μm), and the radius of curvature of the convex mirror 13b in the Y-Z cross section is 20 μm or more and 30 μm or less (as one example, 25 μm).

Actions and effects of the optical component 10 and the optical module 1 configured as described above will be described. The optical component 10 has the first surface 11, the second surface 12, and the third surface 13, and the light L is incident on the first surface 11. The third surface 13 includes a convex mirror 13b that reflects the light L incident on the first surface 11 toward the second surface 12. Since the third surface 13 includes the convex mirror 13b, the beam diameter of the light L traveling from the convex mirror 13b toward the second surface 12 can be expanded. For example, the light L after being reflected by the convex mirror 13b the has a beam diameter larger than a beam diameter of the light L before the reflection. The second surface 12 includes the lens 12b, and the lens 12b emits the light L, which is reflected from the convex mirror 13b, as collimated light. Therefore, the light L of which the beam diameter is expanded by the convex mirror 13b can be emitted to the outside of the optical component 10 as collimated light. In the optical component 10, since the convex mirror 13b that expands the beam diameter of the light L is formed on the third surface 13, and the lens 12b that converts the light L into collimated light is formed on the second surface 12 intersecting the third surface 13, the need for a long optical path length can be eliminated. Therefore, the optical path length of the optical components 10 can be shortened, and the optical components 10 can be mounted at high density. As shown in FIG. 2, when two optical components 10 are disposed above and below to face each other along the third direction D3, regarding alignment between an optical axis of the lower optical component 10 and an optical axis of the upper optical component 10, the tolerance for misalignment between the optical axes can be increased by expanding the beam diameter. Accordingly, a decrease in the efficiency of optical coupling between the two optical components 10 can be reduced. In addition, for example, as shown in FIG. 1, since the optical components 10 are fixed to the plurality of respective silicon photonics elements 3b formed in a wafer state, the second optical component 3 emits collimated light along a direction perpendicular to a wafer surface (the third direction D3), so that each of the second optical components 3 can be inspected in a wafer state.

As described above, when the direction in which the third surface 13 extends in the above-described cross section is defined as the X direction, the direction in which the third surface 13 extends and which is orthogonal to the X direction is defined as the Y direction, and the direction orthogonal to the third surface 13 is defined as the Z direction, the length of the optical component 10 in the X direction, the length of the optical component 10 in the Y direction, and the length of the optical component 10 in the Z direction may be 300 μm or less. In this case, since the optical components 10 can be downsized, the optical components 10 can be mounted at higher density. As described above, the curvature of the convex mirror 13b when cut by a plane extending in both the Z direction and the X direction may be different from the curvature of the convex mirror 13b when cut by a plane extending in both the Y direction and the Z direction. In this case, the light L emitted from the lens 12b can be made nearly symmetrical.

As described above, the angle of the third surface 13 with respect to the optical axis of the light L incident on the first surface 11 may be 35° or more and 42° or less. In this case, the non-reflected component of the light L at the convex mirror 13b can be reduced.

The optical module 1 includes the first optical component 2 including the optical component 10 and the optical fiber 2b fixed to the first surface 11 of the optical component 10, and the second optical component 3 including the optical component 10 and the silicon photonics element 3b fixed to the first surface 11 of the optical component 10. The lens 12b of the optical component 10 of the first optical component 2 and the lens 12b of the optical component 10 of the second optical component 3 are optically coupled to each other. In the optical module 1, since each of the first optical component 2 including the optical fiber 2b and the second optical component 3 including the silicon photonics element 3b includes the optical component 10, the optical path length can be shortened, and the optical components 10 and the optical modules 1 can be mounted at high density.

Next, various modification examples of the optical module and the optical component according to the present disclosure will be described. Some of configurations of the optical modules and the optical components according to the various modification examples are the same as some of the configurations of the optical module 1 and the optical component 10 described above. Therefore, hereinafter, descriptions that overlap with the descriptions of the optical module 1 and the optical component 10 will be omitted as appropriate with duplicate configurations denoted by the same reference signs.

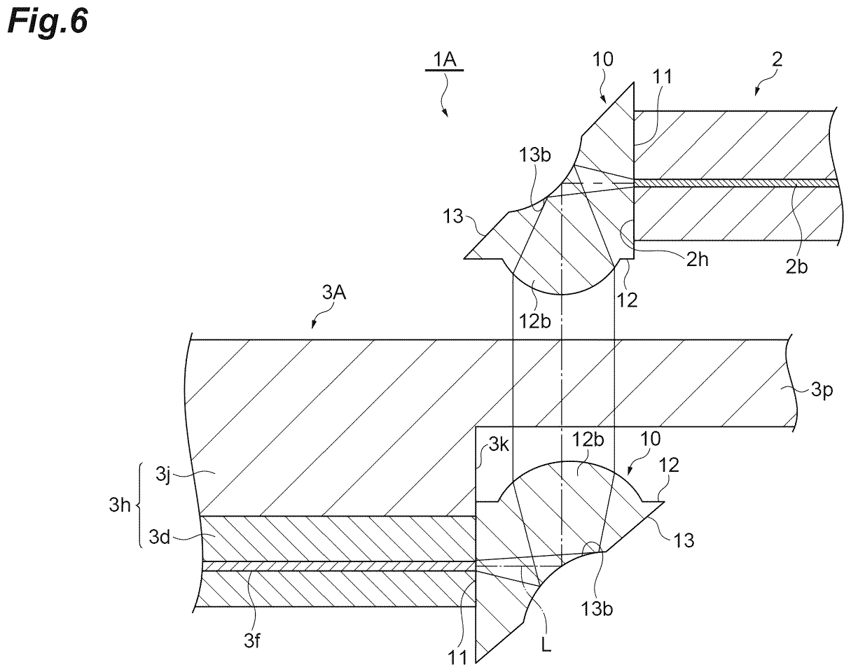

FIG. 6 is a view schematically showing a cross section of an optical module 1A according to a first modification example. As shown in FIG. 6, the optical module 1A includes the first optical component 2 and a second optical component 3A. The second optical component 3A differs from the second optical component 3 described above in that the second optical component 3A includes a silicon photonics element 3h having a shape different from that of the silicon photonics element 3b. The silicon photonics element 3h includes the SiN layer 3d and a Si layer 3j laminated on the SiN layer 3d.

The Si layer 3j includes an end face 3k to which the first surface 11 of the optical component 10 is fixed, and a protruding portion 3p protruding from an upper end of the end face 3k and located above the optical component 10. The protruding portion 3p is interposed between the optical component 10 fixed to the optical fiber 2b and the optical component 10 fixed to the silicon photonics element 3h. The light L from the lens 12b of the optical component 10 fixed to the silicon photonics element 3h is, for example, light in a communication wavelength band, and transmits through the Si layer 3j. The lens 12b of the optical component 10 fixed to the silicon photonics element 3h is optically coupled to the lens 12b of the optical component 10, which is fixed to the optical fiber 2b, through the protruding portion 3p.

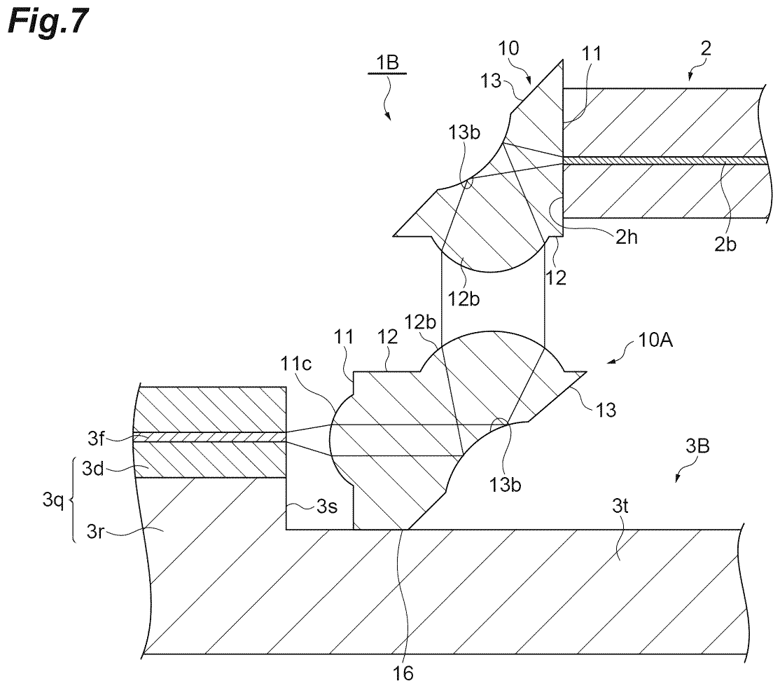

FIG. 7 is a view schematically showing a cross section of an optical module 1B according to a second modification example. As shown in FIG. 7, the optical module 1B includes the first optical component 2 and a second optical component 3B. The second optical component 3B includes a silicon photonics element 3q having a shape different from that of the silicon photonics element 3b, and an optical component 10A having a shape different from that of the optical component 10. The optical component 10A differs from the optical component 10 described above in that the optical component 10A includes a convex lens 11c optically coupled to the silicon photonics element 3q, and a fixing portion 16 fixed to the silicon photonics element 3q. The fixing portion 16 extends along the second surface 12 between the first surface 11 and the third surface 13.

The silicon photonics element 3q includes the SiN layer 3d and a Si layer 3r laminated on the SiN layer 3d. The Si layer 3r includes an end face 3s facing the optical component 10A, and a protruding portion 3t which protrudes from a lower end of the end face 3s and to which the optical component 10A is fixed. The fixing portion 16 of the optical component 10A is fixed to the protruding portion 3t. In a state where the fixing portion 16 is fixed to the silicon photonics element 3q (the protruding portion 3t), the convex lens 11c of the optical component 10A is optically coupled to the optical waveguide 3f of the silicon photonics element 3q.

As described above, the optical module 1B according to the second modification example includes the first optical component 2 including the optical component 10 and the optical fiber 2b fixed to the first surface 11 of the optical component 10, and the second optical component 3B including the optical component 10A and the silicon photonics element 3q fixed to the optical component 10A. The silicon photonics element 3q includes the end face 3s facing the first surface 11 of the optical component 10, and the protruding portion 3t protruding from the end face 3s. The optical component 10A of the second optical component 3B includes the fixing portion 16 fixed to the protruding portion 3t, and the convex lens 11c optically coupled to the silicon photonics element 3q in a state where the fixing portion 16 is fixed to the protruding portion 3t. In the optical module 1B, since the first optical component 2 including the optical fiber 2b and the second optical component 3B including the silicon photonics element 3q include the optical components 10 and 10A, respectively, the optical path length can be shortened, and the optical components 10 and 10A and the optical modules 1B can be mounted at high density.

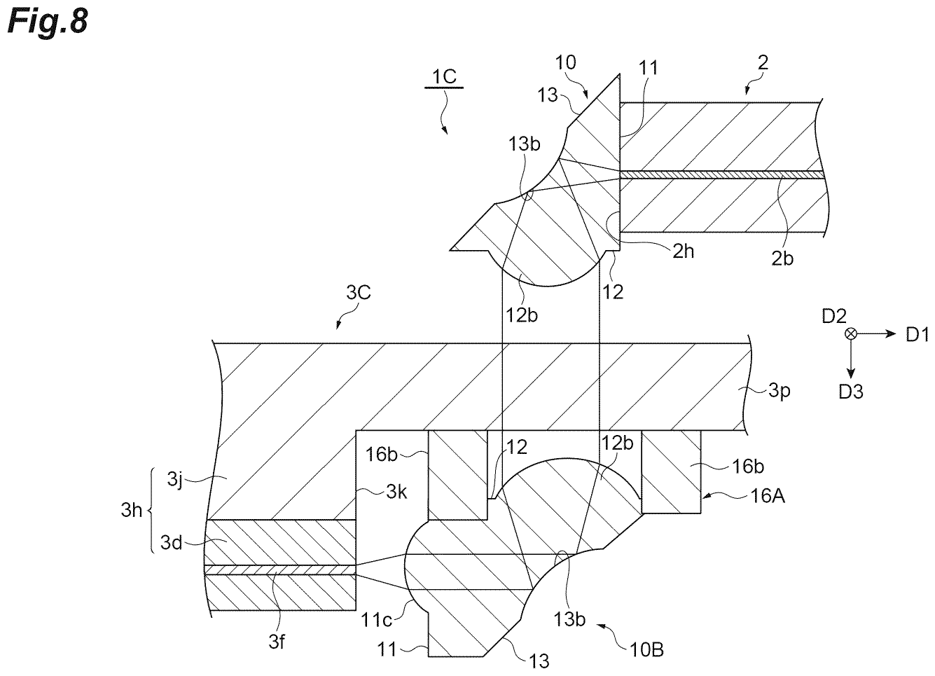

FIG. 8 is a view schematically showing a cross section of an optical module 1C according to a third modification example. As shown in FIG. 8, the optical module 1C includes the first optical component 2 and a second optical component 3C. The second optical component 3C includes the silicon photonics element 3h and an optical component 10B having a shape different from that of the optical component 10A. The optical component 10B includes a fixing portion 16A provided on the second surface 12, instead of the fixing portion 16 described above. The fixing portion 16A is fixed to the protruding portion 3p of the silicon photonics element 3h. The fixing portion 16A includes a plurality of protruding portions 16b protruding from the second surface 12. For example, the plurality of protruding portions 16b are arranged along the first direction D1. The fixing portion 16A is fixed to the silicon photonics element 3h by fixing upper surfaces of the protruding portions 16b to a lower surface of the protruding portion 3p.

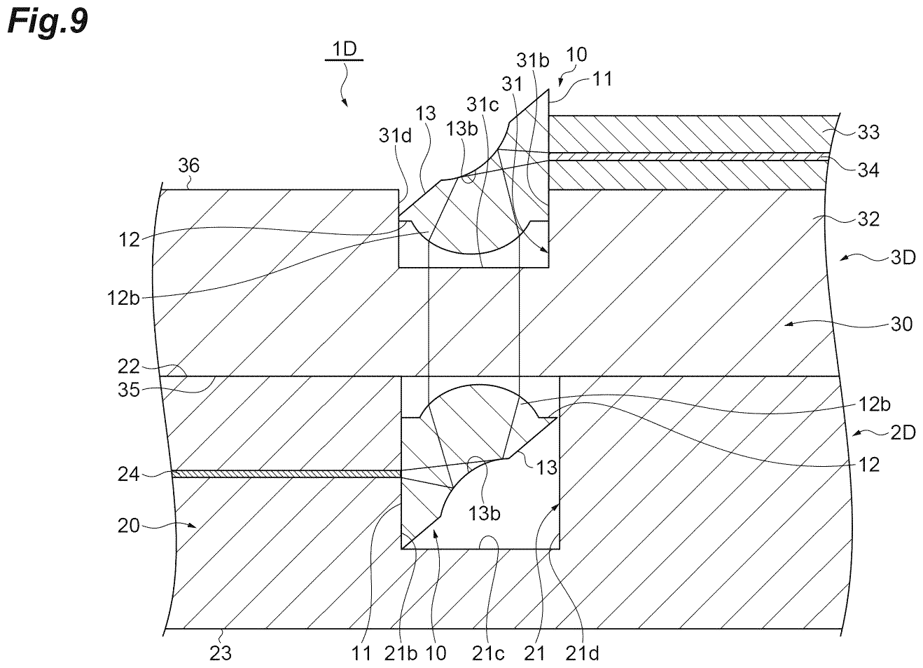

FIG. 9 is a view schematically showing a cross section of an optical module 1D according to a fourth modification example. As shown in FIG. 9, the optical module 1D includes a first optical component 2D and a second optical component 3D. The first optical component 2D includes the optical component 10 and a glass substrate 20 in which a first recess 21 in which the first surface 11 of the optical component 10 is fixed and into which the optical component 10 is inserted is formed. The second optical component 3D includes the optical component 10 and a silicon photonics element 30 in which a second recess 31 in which the first surface 11 of the optical component 10 is fixed and into which the optical component 10 is inserted is formed.

The glass substrate 20 has a first surface 22 and a second surface 23 opposite to the first surface 22. The first recess 21 opens to the first surface 22. The glass substrate 20 includes a glass waveguide 24 extending toward the first recess 21. The glass waveguide 24 is optically coupled to the silicon photonics element 30 through the optical component 10 of the first optical component 2D and the optical component 10 of the second optical component 3D. The first recess 21 is defined by an inner side surface 21b on which the glass waveguide 24 is formed and to which the first surface 11 of the optical component 10 is fixed, a bottom surface 21c facing the optical component 10 along the third direction D3, and an inner side surface 21d facing the inner side surface 21b along the first direction D1.

The silicon photonics element 30 includes a Si layer 32 and a SiN layer 33 laminated on the Si layer 32. The silicon photonics element 30 includes an optical waveguide 34, and for example, the optical waveguide 34 is formed in the SiN layer 33. The optical waveguide 34 is optically coupled to the glass waveguide 24 through the optical component 10 of the second optical component 3D and the optical component 10 of the first optical component 2D. The Si layer 32 has a third surface 35 fixed to the first surface 22 of the glass substrate 20, and a fourth surface 36 opposite to the third surface 35. The second recess 31 opens to the fourth surface 36. The second recess 31 is defined by an inner side surface 31b facing the first surface 11 of the optical component 10, a bottom surface 31c facing the optical component 10 along the third direction D3, and an inner side surface 31d facing the inner side surface 31b along the first direction D1.

As described above, the optical module 1D includes the first optical component 2D including the optical component 10 and the glass substrate 20 in which the first recess 21 in which the first surface 11 of the optical component 10 is fixed and into which the optical component 10 is inserted is formed, and the second optical component 3D including the optical component 10 and the silicon photonics element 30 in which the second recess 31 in which the first surface 11 of the optical component 10 is fixed and into which the optical component 10 is inserted is formed. The lens 12b of the optical component 10 of the first optical component 2D and the lens 12b of the optical component 10 of the second optical component 3D are optically coupled to each other. In the optical module 1D, since each of the first optical component 2D including the glass substrate 20 and the second optical component 3D including the silicon photonics element 30 includes the optical component 10, the optical path length can be shortened, and the optical components 10 and the optical modules 1D can be mounted at high density. Further, the optical components 10 are each inserted into the first recess 21 and the second recess 31, which contributes to downsizing of the optical module 1D.

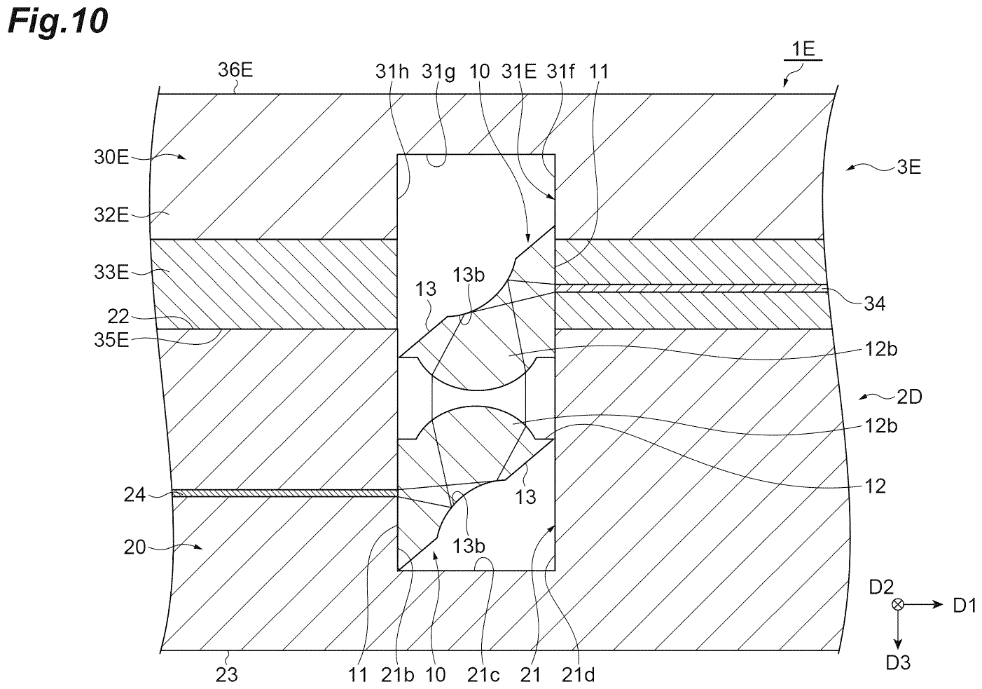

FIG. 10 is a view schematically showing a cross section of an optical module 1E according to a fifth modification example. As shown in FIG. 10, the optical module 1E includes the first optical component 2D and a second optical component 3E. The second optical component 3E includes the optical component 10 and a silicon photonics element 30E in which a second recess 31E in which the first surface 11 of the optical component 10 is fixed is formed. The silicon photonics element 30E includes a SiN layer 33E in which the optical waveguide 34 is formed, and a Si layer 32E laminated on the SiN layer 33E.

The silicon photonics element 30E has a third surface 35E fixed to the first surface 22 of the glass substrate 20, and a fourth surface 36E opposite to the third surface 35E. The second recess 31E opens to the third surface 35E. The second recess 31E faces the first recess 21 along the third direction D3, and an internal space of the second recess 31E communicates with an internal space of the first recess 21. The second recess 31E is defined by an inner side surface 31f facing the first surface 11 of the optical component 10, a bottom surface 31g facing the bottom surface 21c of the first recess 21 along the third direction D3, and an inner side surface 31h facing the inner side surface 31f along the first direction D1.

As described above, similarly to the optical module 1D described above, the optical module 1E includes the first optical component 2D including the glass substrate 20 in which the first recess 21 is formed, and the second optical component 3E including the silicon photonics element 30E in which the second recess 31E is formed. The lens 12b of the optical component 10 of the first optical component 2D and the lens 12b of the optical component 10 of the second optical component 3E are optically coupled to each other. Therefore, the same actions and effects as those of the optical module 1D can be obtained from the optical module 1E.

The embodiment and various modification examples of the optical component and the optical module according to the present disclosure have been described above. However, the optical component and the optical module according to the present disclosure are not limited to the embodiment or the modification examples described above, and may be further modified within the scope of the concept described in the claims. Namely, the configuration, shape, size, material, number, and disposition mode of each portion of the optical component and the optical module according to the present disclosure can be changed as appropriate within the scope of the concept.

What is claimed is:

1. An optical component comprising:
a first surface;
a second surface intersecting the first surface; and
a third surface intersecting the first surface and the second surface in a cross section orthogonal to both the first surface and the second surface,
wherein the third surface includes a convex mirror that reflects light incident on the first surface toward the second surface, and
the second surface includes a lens that emits the light, which is reflected from the convex mirror, as collimated light.

2. The optical component according to claim 1,
wherein when a direction in which the third surface extends in the cross section is defined as an X direction, a direction in which the third surface extends and which is orthogonal to the X direction is defined as a Y direction, and a direction orthogonal to the third surface is defined as a Z direction, a length of the optical component in the X direction, a length of the optical component in the Y direction, and a length of the optical component in the Z direction are 300 μm or less.

3. The optical component according to claim 1,
wherein when a direction in which the third surface extends in the cross section is defined as an X direction, a direction in which the third surface extends and which is orthogonal to the X direction is defined as a Y direction, and a direction orthogonal to the third surface is defined as a Z direction, a curvature of the convex mirror when cut by a plane extending in both the Z direction and the X direction is different from a curvature of the convex mirror when cut by a plane extending in both the Y direction and the Z direction.

4. The optical component according to claim 1,
wherein an angle of the third surface with respect to an optical axis of the light incident on the first surface is 35° or more and 42° or less.

5. An optical module comprising:
a first optical component including the optical component according to claim 1, and an optical fiber fixed to the first surface of the optical component; and
a second optical component including the optical component according to claim 1, and a silicon photonics element fixed to the first surface of the optical component,
wherein the lens of the optical component of the first optical component and the lens of the optical component of the second optical component are optically coupled to each other.

6. An optical module comprising:
a first optical component including the optical component according to claim 1, and an optical fiber fixed to the first surface of the optical component; and
a second optical component including the optical component according to claim 1, and a silicon photonics element fixed to the optical component,
wherein the silicon photonics element includes an end face facing the first surface of the optical component, and a protruding portion protruding from the end face, and
the optical component of the second optical component includes a fixing portion fixed to the protruding portion, and a convex lens optically coupled to the silicon photonics element in a state where the fixing portion is fixed to the protruding portion.

7. An optical module comprising:
a first optical component including the optical component according to claim 1, and a glass substrate in which a first recess in which the first surface of the optical component is fixed and into which the optical component is inserted is formed; and
a second optical component including the optical component according to claim 1, and a silicon photonics element in which a second recess in which the first surface of the optical component is fixed and into which the optical component is inserted is formed,
wherein the lens of the optical component of the first optical component and the lens of the optical component of the second optical component are optically coupled to each other.
